(19) United States
(12) Patent Application Publication
(10) Pub. No.: US 2017/0154377 A1
(43) Pub. Date: Jun. 1, 2017

(54) NAVIGATION TERMINAL, PRODUCT RESERVATION SYSTEM, AND METHOD OF RESERVING PRODUCT

(71) Applicant: OPTiM Corporation, Saga-shi (JP)

(72) Inventor: Shunji SUGAYA, Tokyo (JP)

(21) Appl. No.: 15/049,189

(22) Filed: Feb. 22, 2016

(30) Foreign Application Priority Data
Nov. 27, 2015 (JP) 2015-232443

(51) Int. Cl. G06Q 30/06; G01C 21/36

(52) U.S. Cl. CPC G06Q 30/0639; G01C 21/3661; G06Q 30/0625

(57) ABSTRACT

The present invention is to provide a navigation terminal, a product reservation system, and a method of reserving a product that improve the convenience. The navigation terminal 100 capable of communicating with a predetermined server, searching a route from a present location to a destination, and calculating an expected time of arrival from the present location receives an input of destination data on a destination to move forward when moving to a shop; transmits the destination data to the server; transmits an expected time of arrival at the destination to the server; receives product list data of the shop at the destination to move forward from the server and then receives a selection of a product; and transmits product data on the selected product to the server.

### TECHNICAL FIELD

This application claims priority to Japanese Patent Application No. 2015-232443 filed on Nov. 27, 2015, the entire contents of which are incorporated by reference herein.

The present invention relates to a navigation terminal, a product reservation system, and a method of reserving a product that are capable of searching a route from a present location to a destination and calculating the expected time of arrival at the destination.

### BACKGROUND ART

Recently, the system that shows a user a route to a shop requested from the user and executes an order for a product by using an on-board unit with a navigation function has been provided. In such a system, a user can be guided through the route and can order a product at the same time by operating the on-board unit.

For example, Patent Document 1 discloses the constitution to transmit vehicle identification information identifying a vehicle that the user gets on and order information indicating an order to a shop server that makes settlement.

### CITATION LIST

### Patent Literature

Patent Document 1: JP 2010-176550 A

### SUMMARY OF INVENTION

In the constitution of Patent Document 1, a product can be ordered, but the completion timing of preparation for the ordered product is not necessarily synchronized with the timing of a user's arrival at the shop. This may cause the user to wait at the shop until receiving the product and otherwise to arrive at the shop long after the preparation for a product is completed. Therefore, the constitution of Patent Document 1 is less convenience.

Then, the present invention focuses on a solution to the problem that is to transmit the expected time of arrival and notify the shop of the arrival time of the user to improve the convenience.

An objective of the present invention is to provide a navigation terminal, a product reservation system, and a method of reserving a product that improve the convenience.

According to the first aspect of the present invention, a navigation terminal capable of communicating with a predetermined server, searching a route from a present location to a destination, and calculating an expected time of arrival from the present location includes:

a destination data input receiving unit that receives an input of destination data on a destination to move forward when moving to a shop;

a destination data transmission unit that transmits the destination data to the server;

an expected time-of-arrival transmitting unit that transmits an expected time of arrival at the destination to the server;

a product selection receiving unit that receives product list data of the shop at the destination to move forward from the server and then receives a selection of a product; and

a product data transmitting unit that transmits product data on the selected product to the server.

According to the first aspect of the present invention, a navigation terminal capable of communicating with a predetermined server, searching a route from a present location to a destination, and calculating an expected time of arrival from the present location receives an input of destination data on a destination to move forward when moving to a shop; transmits the destination data to the server; transmits an expected time of arrival at the destination to the server; receives product list data of the shop at the destination to move forward from the server and then receives a selection of a product; and transmits product data on the selected product to the server.

The first aspect of the present invention falls into the category of a navigation terminal, but the categories of the method, etc., have the same functions and effects.

According to the second aspect of the present invention, the navigation terminal according to the first aspect of the present invention further includes:

a change instruction receiving unit that receives a change instruction of the destination to move forward from the server; and

a destination change unit that changes the destination based on the change instruction.

According to the second aspect of the present invention, the navigation terminal according to the first aspect of the present invention further receives a change instruction of the destination to move forward from the server; and changes the destination based on the change instruction.

According to the third aspect of the present invention, the navigation terminal according to the first aspect of the present invention further includes:

a completion notification receiving unit that receives a completion notification that a product has been prepared from the server; and

a display unit that displays the received completion notification on the navigation terminal itself.

According to the third aspect of the present invention, the navigation terminal according to the first aspect of the present invention further receives a completion notification that a product has been prepared from the server; and displays the received completion notification on the navigation terminal itself.

According to the fourth aspect of the present invention, a product reservation system includes:

a destination data input receiving unit that receives an input of destination data on a destination to move forward when moving to a shop;

a navigation unit that searches a route from a present location to a destination and guides a user;

a display unit that displays product list data of the shop at the destination to move forward based on the destination data; and

a notification unit that notifies a terminal of the shop of an expected time of arrival at the destination.

According to the fourth aspect of the present invention, a product reservation system receives an input of destination data on a destination to move forward when moving to a shop; searches a route from a present location to a destination and guides a user; displays product list data of the shop at the destination to move forward based on the destination data; and notifies a terminal of the shop of an expected time of arrival at the destination.

The fourth aspect of the present invention falls into the category of a product reservation system, but the categories of the method, etc., have the same functions and effects.

According to the fifth aspect of the present invention, the product reservation system according to the fourth aspect of the present invention further includes:

a product selection receiving unit that receives a selection of a product from the displayed product list data;

a different shop search unit that searches a different shop offering the same product as the selected product; and

a destination change unit that transmits a change instruction to change the input destination if a different shop offering the same product is searched.

According to the fifth aspect of the present invention, the product reservation system according to the fourth aspect of the present invention further receives a selection of a product from the displayed product list data; searches a different shop offering the same product as the selected product; and transmits a change instruction to change the input destination if a different shop offering the same product is searched.

According to the sixth aspect of the present invention, a method of reserving a product, the method being executed by a navigation terminal capable of communicating with a predetermined server, searching a route from a present location to a destination, and calculating an expected time of arrival from the present location, includes the steps of:

receiving an input of destination data on a destination to move forward when moving to a shop;

transmitting the destination data to the server;

transmitting an expected time of arrival at the destination to the server;

receiving product list data of the shop at the destination to move forward from the server and then receiving a selection of a product; and

transmitting product data on the selected product to the server.

According to the seventh aspect of the present invention, a method of reserving a product, the method being executed by a product reservation system, includes the steps of:

receiving an input of destination data on a destination to move forward when moving to a shop;

searching a route from a present location to a destination and guiding a user;

displaying product list data of the shop at the destination to move forward based on the destination data; and

notifying a terminal of the shop of an expected time of arrival at the destination.

The present invention can provide a navigation terminal, a product reservation system, and a method of reserving a product that improve the convenience.

### BRIEF DESCRIPTION OF DRAWINGS

FIG. 1 shows a schematic diagram of the product reservation system 1.

FIG. 2 shows an overall configuration diagram of the product reservation system 1.

FIG. 3 shows a functional block diagram of the order management server 10, the navigation terminal 100, and the shop terminal 200.

FIG. 4 shows the flow chart of the product reservation process executed by the order management server 10 and the navigation terminal 100

FIG. 5 shows the flow chart of the order process executed by the order management server 10, the navigation terminal 100, and the shop terminal 200.

FIG. 6 shows the flow chart of the destination change process executed by the order management server 10 and the navigation terminal 100.

FIG. 7 shows a navigation screen displayed on the navigation terminal 100.

FIG. 8 shows a navigation screen displayed on the navigation terminal 100.

FIG. 9 shows a product list data table.

FIG. 10 shows a product list screen displayed on the navigation terminal 100.

FIG. 11 shows a settlement completion notification screen displayed on the navigation terminal 100.

FIG. 12 shows a shop database.

FIG. 13 shows a product offer screen displayed on the shop terminal 200.

FIG. 14 shows a preparation completion notification displayed on the navigation terminal 100.

FIG. 15 shows a destination change notification displayed on the navigation terminal 100.

### DESCRIPTION OF EMBODIMENTS

Embodiments of the present invention will be described below with reference to the attached drawings. However, this is illustrative only, and the technological scope of the present invention is not limited thereto.

### Overview of Product Reservation System 1

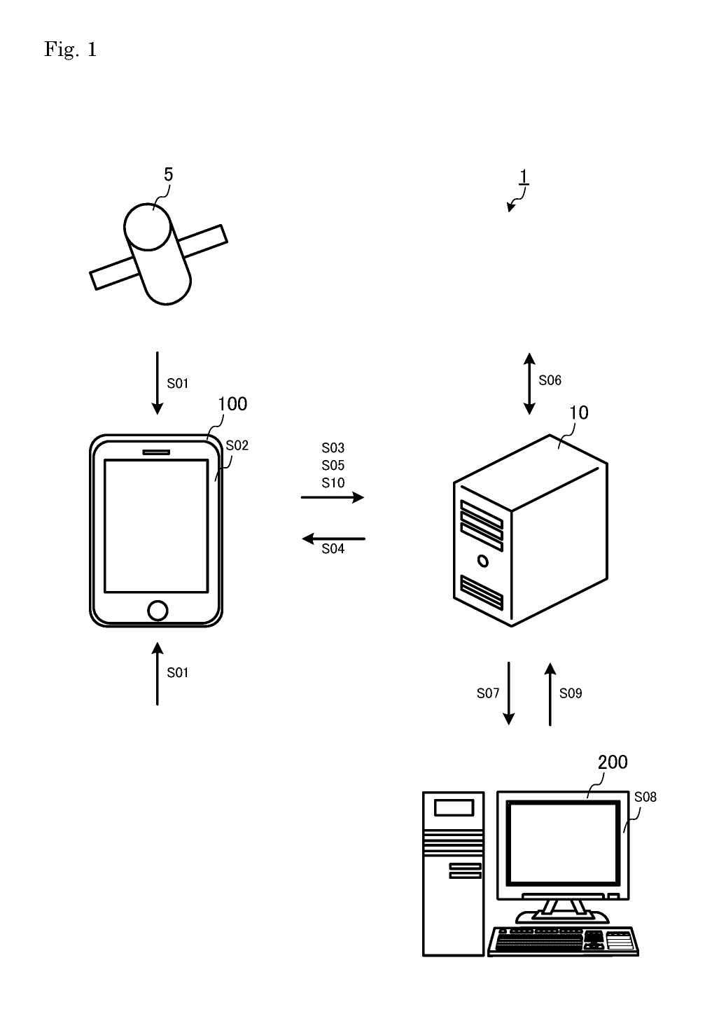

The overview of the present invention will be described below with reference to FIG. 1. FIG. 1 shows a schematic diagram of the product reservation system 1 according to a preferable embodiment of the present invention. The product reservation system 1 includes an order management server 10, a navigation terminal 100, a shop terminal 200, and a GPS 5. The respective number of the order management server 10, the navigation terminal 100, and the shop terminal 200 may not limited to one and may be more than one. The processes to be described later may be each performed by any of the above-mentioned devices.

The order management server 10 is a server device capable of data communication with the navigation terminal 100 and the shop terminal 200.

The navigation terminal 100 is a terminal device with a capability of route guidance and data communication with the order management server 10. The navigation terminal 100 is a navigation device such as an electrical appliance, for example, a wearable terminal such as glass terminal or a head mounted display, a mobile phone, a mobile information terminal, a personal computer, a net book terminal, a slate terminal, an electronic book terminal, or a portable music player, an on-board car navigation terminal, a portable car navigation terminal, or a portable navigation device (hereinafter referred to as “PND”).

The shop terminal 200 is an electrical appliance communicative with the order management server 10, for example, an electrical appliance like the navigation terminal 100 or a stationary information terminal.

First, the navigation terminal 100 acquires its location information from a GPS 5 as a present location and receives an input of a destination to move forward (step S01). For example, the navigation terminal 100 starts a predetermined application such as a navigation application or a map application and receives an input of the destination through operation of this application. The navigation terminal 100 displays a map based on the own stored map data and then displays the present location and the destination on the map. The navigation terminal 100 receives an input of a point such as a shop and a facility where a product or a service is to be offered as the destination. The shop is a restaurant or a supermarket, for example. The facility is a commercial complex or a communal facility, for example. In this embodiment, a shop is input as the destination. The points other than shops and facilities may be input as the destination. The navigation terminal 100 may download map data from a predetermined server, etc., in each case.

The navigation terminal 100 searches a route from the present location to the destination and calculates the expected time of arrival at the destination, based on the present location, the destination, map information, other road information, etc., (step S02). The navigation terminal 100 displays the searched route and the calculated expected time of arrival. The navigation terminal 100 also displays the route guiding the user on the map based on the searched route.

The navigation terminal 100 transmits product reservation data containing present location data as information on the present location, destination data as information on the destination, expected time-of-arrival data as information on the expected time of arrival, and user data as information on the user to the order management server 10 (step S03).

The order management server 10 receives the product reservation data and transmits a list of products sold by the shop indicated from the destination data as product list data to the navigation terminal 100 based on the product reservation data (step S04).

The navigation terminal 100 receives the product list data and displays product list based on the product list data. The navigation terminal 100 receives a selection of a product displayed in the product list and transmits purchase product data containing product data on the selected product, settlement data, and user data to the order management server 10 (step S05). The settlement data is various kinds of information on a credit card or on electronic money, for example. The settlement data may contain data that the user previously registered or that the user input when a selection of a product is received.

The order management server 10 receives the purchase product data and performs the settlement process based on the received purchase product data (step S06). In the settlement process, for example, payment is collected by accessing a server of the credit card or the electronic money company, etc.

The order management server 10 transmits product offer data containing purchase product data and product reservation data to a shop terminal 200 of the shop at the destination based on the received purchase product data and the product reservation data (step S07). The order management server 10 may transmit only user data, product data, and arrival time data from the purchase product data and the product reservation data.

The shop terminal 200 receives and displays the product offer data on its screen (step S08). The shop employee prepares to offer a product based on this product offer data.

When preparation for a product is completed, the shop terminal 200 transmits a completion notification that a product has been prepared to the order management server 10 (step S09).

The order management server 10 receives and transmits the completion notification to the navigation terminal 100 (step S10).

The navigation terminal 100 receives and displays the completion notification on its screen.

### Configuration of Production Reservation System 1

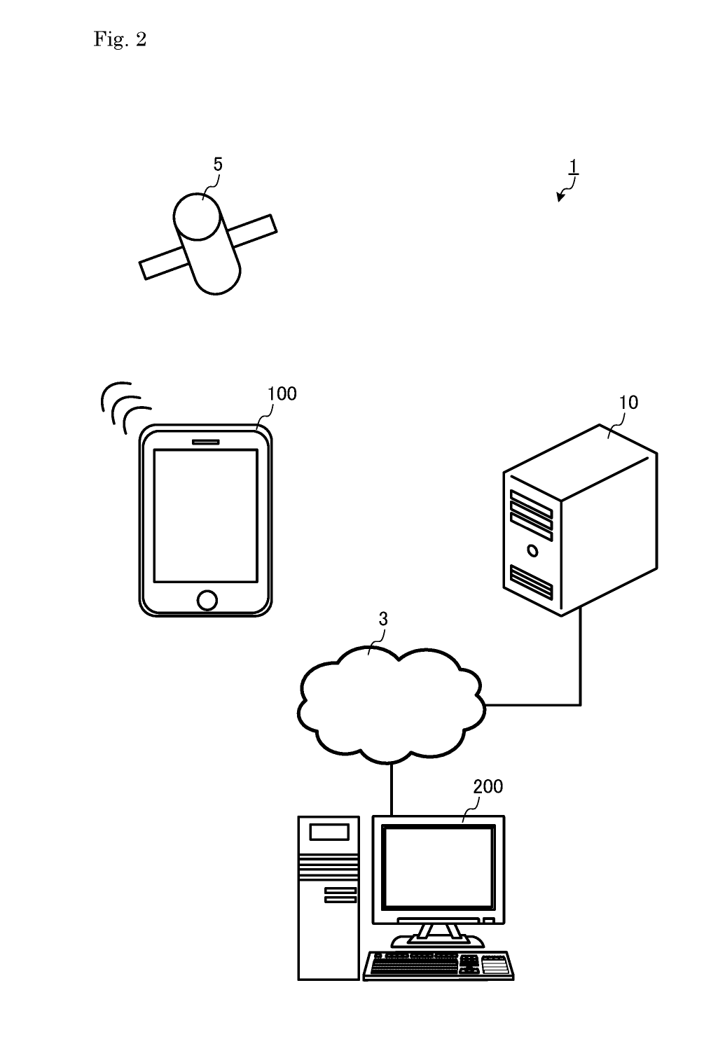

The configuration of the production reservation system 1 will be explained with reference to FIG. 2. FIG. 2 shows a system configuration diagram of the production reservation system 1 according to a preferred embodiment of the present invention. The product reservation system 1 includes an order management server 10, a navigation terminal 100, a shop terminal 200, a GPS 5, and a public line network 3 (e.g., the Internet network, a third and a fourth generation networks).

The order management server 10 is the above-mentioned server device with the functions to be described later.

The navigation terminal 100 is the above-mentioned terminal with the functions to be described later.

The shop terminal 200 is the above-mentioned terminal with the functions to be described later.

The GPS 5 is a general GPS.

### Functions

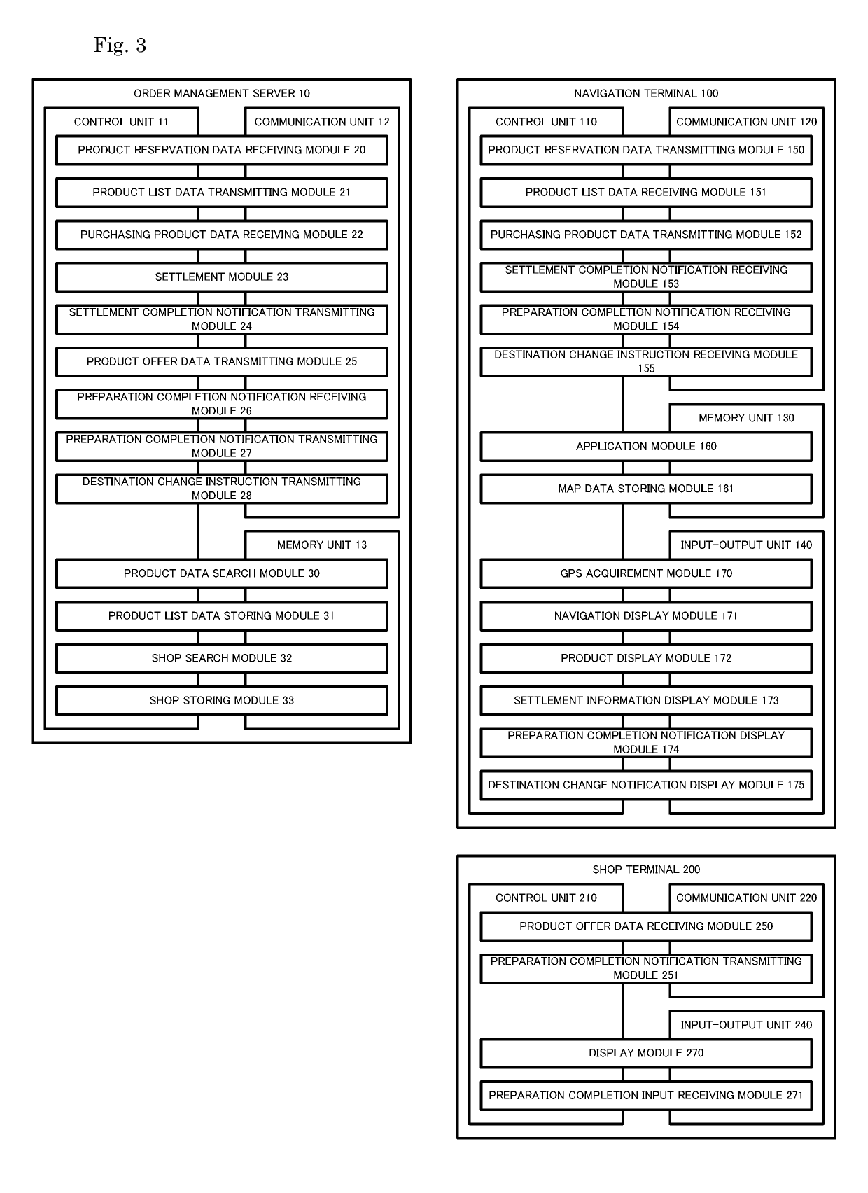

The structure of each device will be described below with reference to FIG. 3. FIG. 3 shows a functional block diagram of the order management server 10, the navigation terminal 100, and the shop terminal 200 according to a preferred embodiment of the present invention.

The order management server 10 includes a control unit 11 provided with a central processing unit (hereinafter referred to as “CPU”), a random access memory (hereinafter referred to as “RAM”), and a read only memory (hereinafter referred to as “ROM”); and a communication unit 12 such as a device capable of communicating with other devices, for example, a Wireless Fidelity or Wi-Fi® enabled device complying with IEEE 802.11.

The order management 10 also includes a memory unit 13 such as a hard disk, a semiconductor memory, a record medium, or a memory card to store data.

In the order management server 10, the control unit 11 reads a predetermined program to run a product reservation data receiving module 20, a product list data transmitting module 21, a purchase product data receiving module 22, a settlement module 23, a settlement completion notification transmitting module 24, a product offer data transmitting module 25, a preparation completion notification receiving module 26, a preparation completion notification transmitting module 27, and a destination change instruction transmitting module 28 in cooperation with the communication unit 12. Furthermore, in the order management server 10, the control unit 11 reads a predetermined program to run a product data search module 30, a product list data storing module 31, a shop search module 32, and a shop storing module 33 in cooperation with the memory unit 13.

The navigation terminal 100 includes a control unit 110 including a CPU, a RAM, and a ROM; and a communication unit 120 such as a device capable of communicating with other devices, for example, a Wi-Fi® enabled device complying with IEEE 802.11 in the same way as the order management server 10.

The navigation terminal 100 also includes a storage unit to store the above-mentioned data as a memory unit 130 in the same way as the order management server 10. The navigation terminal 100 also includes an input-output unit 140 including a display unit outputting and displaying data and images that have been processed by the control unit 110; and an input unit such as a touch panel, a keyboard, or a mouse that receives an input from a user. The navigation terminal 100 also includes a device capable of acquiring its own location information from a GPS. The navigation terminal 100 also includes a device that acquires its own direction by using an electronic compass.

In the navigation terminal 100, the control unit 110 reads a predetermined program to run a product reservation data transmitting module 150, a product list data receiving module 151, a purchase product data transmitting module 152, a settlement completion notification receiving module 153, a preparation completion notification receiving module 154, and a destination change instruction receiving module 155 in cooperation with the communication unit 120.

Furthermore, in the navigation terminal 100, the control unit 110 reads a predetermined program to run an application module 160 and a map data storing module 161 in cooperation with the memory unit 130. Yet furthermore, in the navigation terminal 100, the control unit 110 reads a predetermined program to run a GPS acquirement module 170, a navigation display module 171, a product display module 172, a settlement information display module 173, a preparation completion notification display module 174, and a destination change notification display module 175 in cooperation with the input-output unit 140.

The shop terminal 200 includes a control unit 210 including a CPU, a RAM, and a ROM; and a communication unit 220 such as a device capable of communicating with other devices, for example, a Wi-Fi® enabled device complying with IEEE 802.11 in the same way as the navigation terminal 100.

The shop terminal 200 includes an input-output unit 240 including the above-mentioned display unit and input unit, and a device that acquires the location information of the shop terminal 200 itself from a GPS in the same way as the navigation terminal 100.

In the shop terminal 200, the control unit 210 reads a predetermined program to run a product offer data receiving module 250 and a preparation completion notification transmitting module 251 in cooperation with the communication unit 220. Furthermore, in the shop terminal 200, the control unit 210 reads a predetermined program to run a display module 270 and a preparation completion input receiving module 271 in cooperation with the input-output unit 240.

### Product Reservation Process

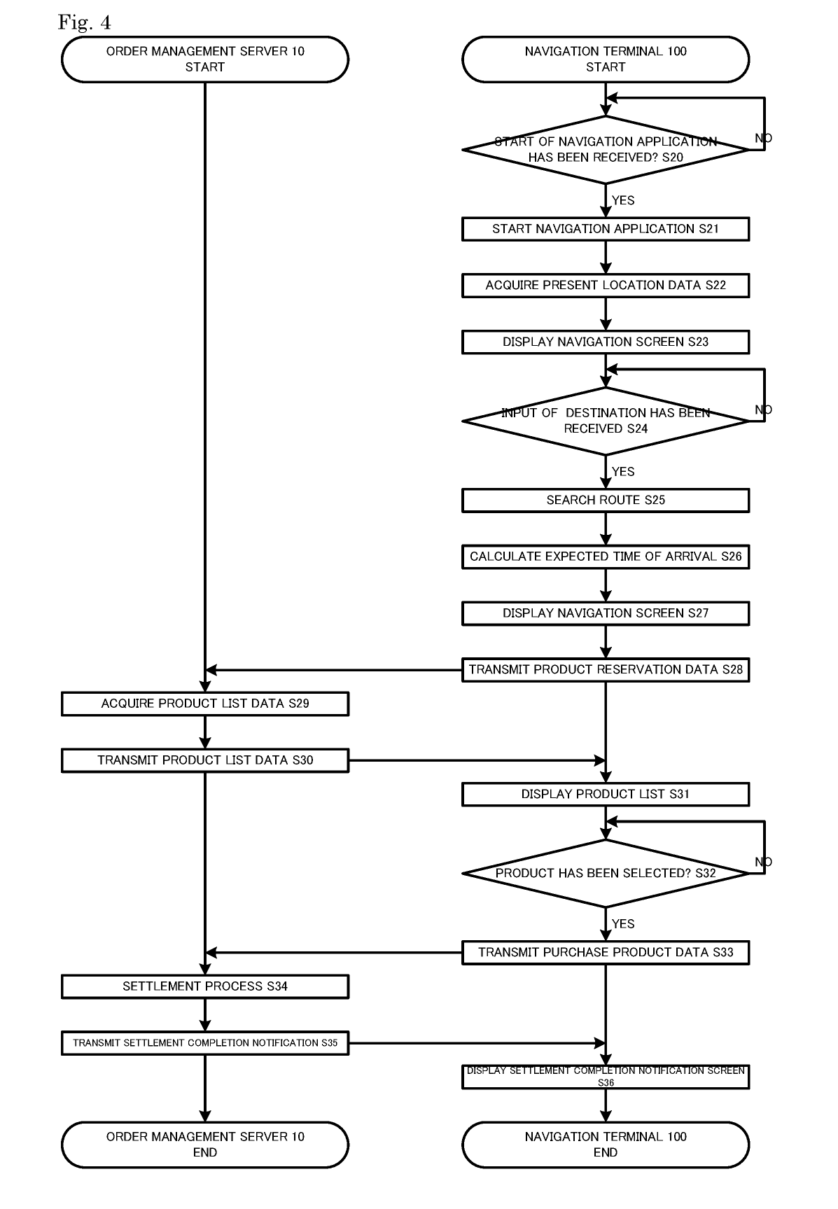

The product reservation process executed by the order management server 10 and the navigation terminal 100 will be described below with reference to FIG. 4. FIG. 4 shows the flow chart of the product reservation process executed by the order management server 10 and the navigation terminal 100. The tasks executed by the modules of the above-mentioned devices are explained below together with this process.

The application module 160 judges whether or not the application module 160 has received a start of a navigation application (step S20). In the step S20, the application module 160 judges whether or not the application module 160 has received the start based on whether or not the application module 160 has received an operation to start a predetermined navigation application. In the step S20, if judging that the application module 160 has not received the start (NO), the application module 160 repeats this step until receiving the start.

On the other hand, if judging that the application module 160 has received the start (YES) in the step S20, the application module 160 starts a navigation application (step S21). This embodiment has a configuration to perform processes by using an application but may not use an application, for example.

The GPS acquirement module 170 acquires present location data indicating the present location of the navigation terminal 100 from a GPS 5 (step S22). The present location contains information on a point where the navigation terminal 100 exists and information on the direction of the navigation terminal 100.

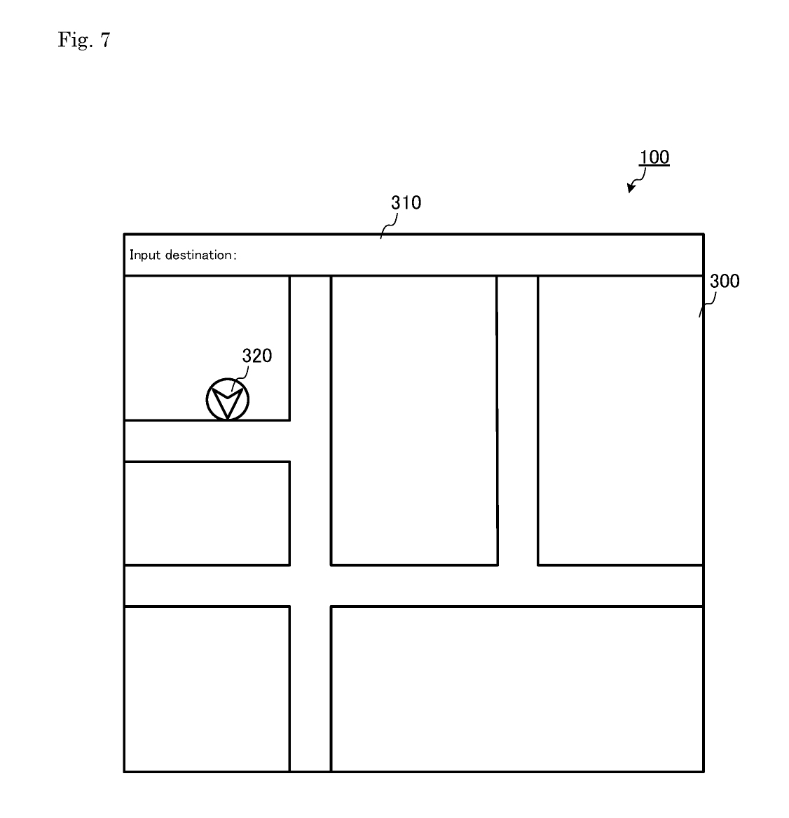

The navigation display module 171 displays the navigation screen shown in FIG. 7 based on the acquired present location data and map data that the map data storing module 161 stores (step S23).

FIG. 7 shows a navigation screen that the navigation display module 171 displays. In FIG. 7, the navigation display module 171 displays a map display area 300 and a destination input area 310. The navigation display module 171 also displays a map based on the map data and a present location icon 320 indicating the present location of the navigation terminal 100 in the map display area 300. The navigation display module 171 also displays a shop, a facility, a landmark, a signal, etc., which are not shown in the attached drawings. The navigation display module 171 also displays a present location icon 320 indicating the location and the direction of the navigation terminal 100 in the map.

The navigation display module 171 judges whether or not the navigation display module 171 has received an input of a destination (step S24). In the step S24, the navigation display module 171 judges whether or not a destination has been input in the destination input area 310 or whether or not a point on the map has been directly specified to judge whether or not the navigation display module 171 has received an input of a destination. The navigation display module 171 receives an input of the above-mentioned point of a shop, a facility, etc., as a destination. In this embodiment, the navigation display module 171 is explained assuming that the shop A is input as a destination.

In the step S24, if judging that the navigation display module 171 has not received an input of a destination (NO), the navigation display module 171 repeats this step until receiving the input.

On the other hand, if judging that the navigation display module 171 has received an input of a destination (YES) in the step S24, the navigation display module 171 searches a route from the present location to the destination based on present location data, destination data, map data, other road information, etc., (step S25). Examples of the other road information include construction information, traffic condition information, closure information, and traffic regulation. The navigation terminal 100 only has to acquire road information from, for example, a predetermined server.

The navigation display module 171 displays the searched route on the map and calculates an expected time of arrival at the destination (step S26). The navigation display module 171 calculates the expected time of arrival based on the searched route to the destination, other road information, etc.

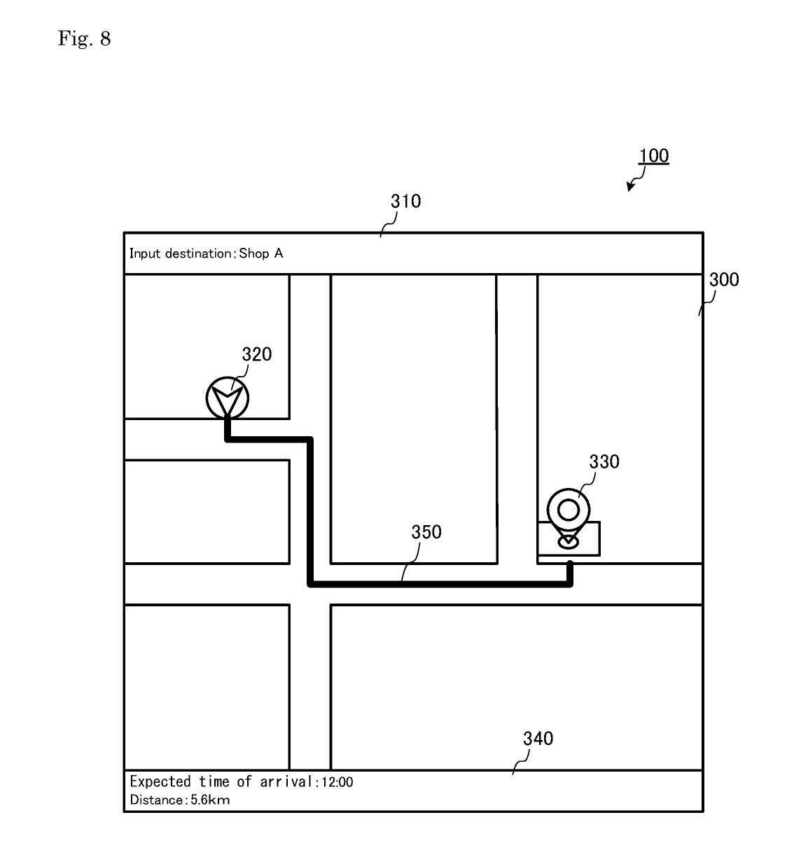

The navigation display module 171 displays the navigation screen shown in FIG. 8 (step S27). The process in the steps S20 to S27 may be a general route guidance one.

In FIG. 8, the navigation display module 171 displays a map display area 300, a destination input area 310, and information display area 340. The navigation display module 171 displays the destination input in the step S24 in the destination input area 310. The navigation display module 171 also displays a map, a present location icon 320, a destination icon 330, and a guide route 350 in the map display area 300. The map and the present location icon 320 are the same as the above-mentioned ones shown in FIG. 7. The destination icon 330 shows a destination. The guide route 350 indicates a route to guide a user to the destination. The navigation display module 171 also displays the calculated expected time of arrival and the distance to the destination in the information display area 340.

The product reservation data transmitting module 150 transmits product reservation data containing the present location data, the destination data, the expected time-of-arrival data, and the user data to the order management server 10 (step S28). The present location data is location information on the present location of the navigation terminal 100. The destination data contains a name, an identifier, location information, etc., of the input destination. The expected time-of-arrival data is information on the expected time of arrival at the destination that the navigation terminal 100 has calculated. The user data contains the name, the identifier, the fleet number, the phone number, etc., of a user. The user data may be information that a user previously registers or inputs any time before this process.

The product reservation data receiving module 20 receives the product reservation data. The product data search module 30 acquires product list data on the products that a shop at the destination sells, based on the destination data contained in the product reservation data (step S29). In the step S29, the product data search module 30 identifies a shop at the destination based on the shop name and the location information contained in the destination data. The product data search module 30 looks up the product list data table associated with this shop and acquires product data registered in the product list data table as the product list data.

### Product List Data Table

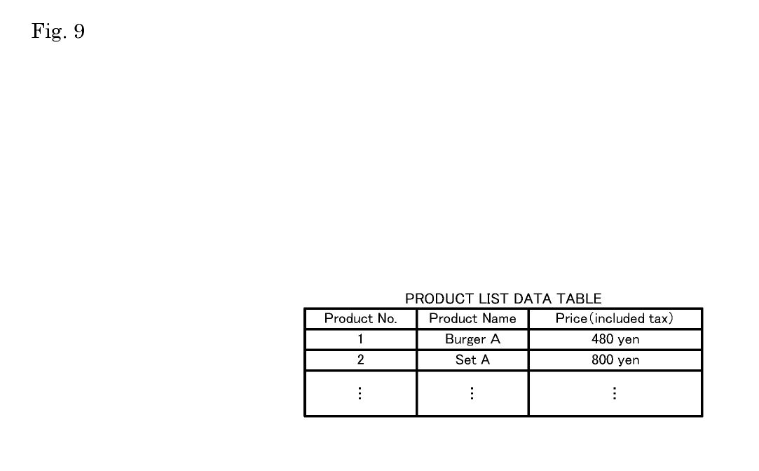

The product list data table that the product list data storing module 31 stores will be described below with reference to FIG. 9. FIG. 9 shows a product list data table. In FIG. 9, the product list data storing module 31 associates and stores a product number with a product name and a price. The product list data storing module 31 stores some or all of the products that each shop offers. The product list data storing module 31 also stores a similar table for some or all of shops. The product number is the identifier of a product. The product name is the name of a product. The price is the price of a product. In FIG. 9, the product No. “1” is associated with the product name “Burger A” and the price “480 yen.” Furthermore, the product No. “2” is associated with the product name “Set A” and the price “800 yen.” The registered items are not limited to those of this embodiment, and other items may be registered. The number of registered products is also not limited to that of this embodiment.

The product list data transmitting module 21 transmits the acquired product list data to the navigation terminal 100 (step S30).

The product list data receiving module 151 receives the product list data. The product display module 172 displays a product list based on the received product list data (step S31). In the step S31, the product display module 172 may superimposed-display the product list on the navigation screen or may temporarily stops navigation to display only the product list.

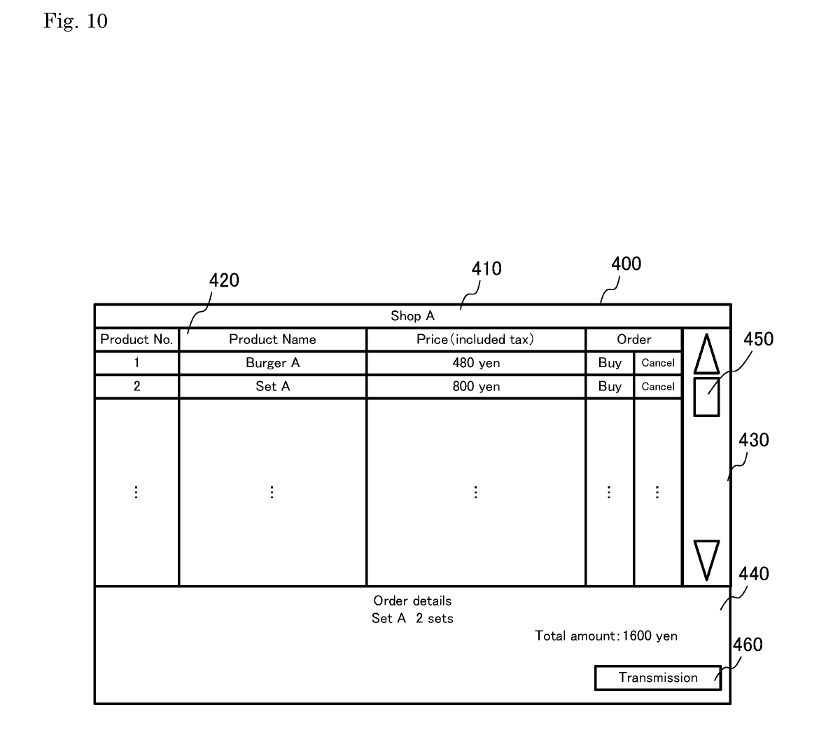

FIG. 10 shows a product list screen that the product display module 172 displays. In FIG. 10, the product display module 172 displays a shop name display area 410, a product information display area 420, a scrollbar display area 430, and a selected product display area 440 in the product display area 400. The location, the arrangement, the content, etc., of each area that the product display module 172 displays can be appropriately changed.

The product display module 172 also displays the name of a shop set as the destination in the shop name display area 410. The product display module 172 displays the shop A.

The product display module 172 also displays a product list based on the product list data and an order icon in the product information display area 420. The product display module 172 also displays a product number, a product name, a price, and an order. The configurations of the product number, the product name, and the price are the same as described above. The order icon is operated by a user to select a desired product and cancel the selected product. The product display module 172 displays the product No. “1,” the product name “Burger A,” the price “480 yen,” the order icons “Purchase icon” and “Cancellation icon.” The product display module 172 also displays the product No. “2,” the product name “Set A,” the price “800 yen,” the order icons “Purchase icon” and “Cancellation icon.”

The product display module 172 also displays a cursor 450 in the selected product display area 430. The product display module 172 receives an operation form the cursor 450 to scroll up and down the displayed product.

The product display module 172 also displays the product name, the number, and the total amount of the selected products, and a transmission icon 460 in the selection product display area 440. The product display module 172 displays the product name “Set A,” the number “2 sets,” and the total amount “1600 yen” as order details. The transmission icon 460 receives an operation from a user to firm the order.

The product display module 172 judges whether or not a product has been selected (step S32). In the step S32, the product display module 172 judges whether or not the product display module 172 has received an operation from the transmission icon 460 to judge whether or not a product has been selected. In the step S32, if judging that a product has not been selected (NO), the product display module 172 repeats this step.

On the other hand, if judging that a product has been selected (YES) in the step S32, the product data transmitting module 172 transmits purchase product data containing product data, settlement data, and user data to the order management server 10 (step S33). In the step S33, the product data contains the product name, the price, and the number of the product that a user selected. The settlement data is various kinds of information on the card number and the valid date of a credit card or on electronic money, for example. The settlement data may contain data that the user previously registered or that the user input when a selection of a product is received. The configuration of the user data is the same as described above. The purchase product data may contain only product data and settlement data or other data in addition to product data and settlement data.

The purchase product data receiving module 22 receives the purchase product data. The settlement module 23 performs the settlement process based on the settlement data contained in the purchase product data (step S34). The settlement process in the step S34 is the same as described above.

The settlement completion notification transmitting module 24 transmits a settlement completion notification that the settlement process has been completed to the navigation terminal 100 (step S35). The settlement completion notification contains an order number representing a number assigned when an order is taken, product data, and a total amount data representing the total amount of the products.

The settlement completion notification receiving module 153 receives the settlement completion notification. The settlement information display module 173 displays the settlement completion notification screen based on the order number, the product data, and the total amount data contained in the settlement completion notification (step S36). The settlement information display module 173 may superimposed-display the settlement completion notification screen on the navigation screen or the product list screen or may temporarily stops navigation to display only the settlement completion notification screen.

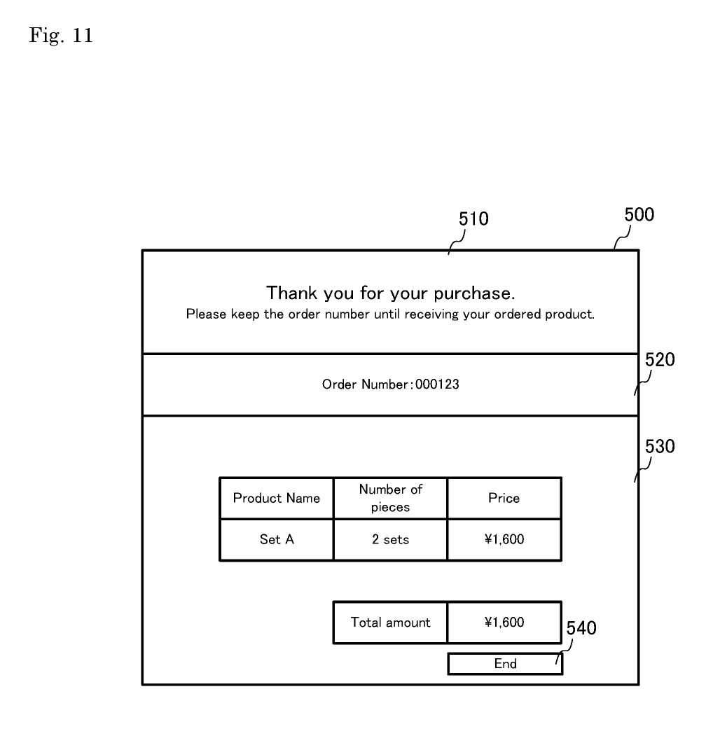

FIG. 11 shows the settlement completion notification screen 500 that the settlement information display module 173 displays. In FIG. 11, the settlement information display module 173 displays a message display area 510, a number display area 520, and a product display area 530 on the settlement completion notification screen 500. The settlement information display module 173 also displays messages that settlement has been completed and then that a product has been ordered, in the message display area 510. The settlement information display module 173 also displays an order number assigned when the order is taken, in the number display area 520. The settlement information display module 173 also displays the product name, the number, and the price of an ordered product, and an end icon 540 in the product display area 530. The end icon 540 receives an operation from a user. The settlement information display module 173 clears the settlement completion notification screen when the operation is received. The location, the arrangement, the content, etc., of each area that the settlement information display module 173 displays can be appropriately changed. The settlement information display module 173 may output a settlement completion notification not on the screen but by voice.

The order management server 10 may not perform the above-mentioned settlement process. In this case, the order management server 10 only has to take only the order for a product to ask a user to pay when the user visits a shop and receives the product.

### Order Process

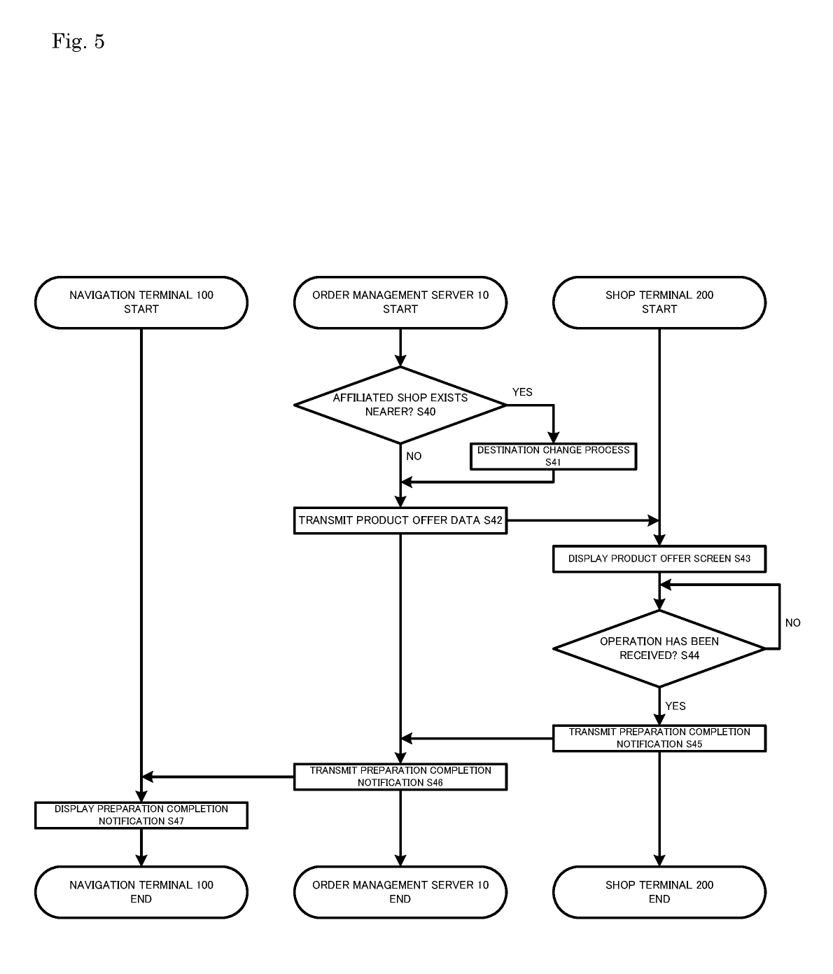

The order process executed by the order management server 10, the navigation terminal 100, and the shop terminal 200 will be described below with reference to FIG. 5. FIG. 5 shows the flow chart of the order process executed by the order management server 10, the navigation terminal 100, and the shop terminal 200. The tasks executed by the modules of the above-mentioned devices are explained below together with this process. This process is performed following the above-mentioned product reservation process.

The shop search module 32 judges whether or not an affiliated shop different from the shop set as the destination exists nearer based on the received product reservation data and purchase product data (step S40). In the step S40, the shop search module 32 looks up the shop database that shop storing module 33 stores and judges whether or not a shop exists near, based on the destination data. The affiliated shop is managed by a same company, operated under franchise, and offering the same product, for example. This embodiment is explained below, assuming that the affiliated shop is operated under franchise as an example. Even if the affiliated shop is of other types, the present invention is applicable.

### Shop Database

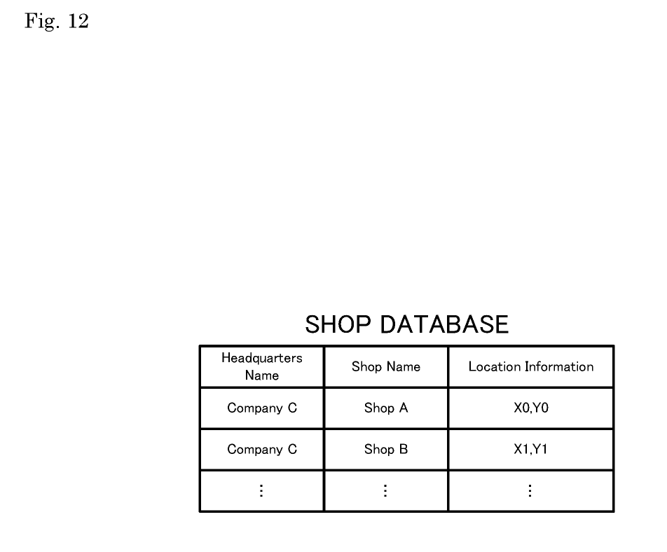

The shop database that the shop storing module 33 stores will be described below with reference to FIG. 12. FIG. 12 shows a shop database. In FIG. 12, the shop storing module 33 associates and stores a headquarters name with a shop name and the location information of a shop. The headquarters name is the name of a franchiser. The shop name is the name of a shop. The location information is on the point where a shop exists. In FIG. 12, the shop storing module 33 associates and stores the headquarters name “Company C” with the shop name “Shop A” and the location information “X0, Y0.” The shop storing module 33 also associates and stores the headquarters name “Company C” with the shop name “Shop B” and the location information “X1, Y1.” The stored items are not limited to those of this embodiment and may be associated with another item, for example, an address. For example, an address may be associated as another item. The number of stored products is also not limited to that of this embodiment. Furthermore, a shop database may exist for each affiliate.

Alternatively, a plurality of affiliates may be collected together as one shop database. Furthermore, the number and the type of the stored items can be appropriately changed.

In the step S40, the shop search module 32 searches the shop name of the destination based on the received destination data and acquires the location information of this shop. The shop search module 32 searches a different shop associated with the same headquarters with which this shop name is associated. The shop search module 32 compares the location information of the shop at the destination with the searched different shop to determine which shop is nearer the present location of the navigation terminal 100.

If the shop search module 32 determines that the searched different shop exists nearer (YES) in the step S40, the order management server 10 performs the destination change process to be described later (step S41).

On the other hand, if the shop search module 32 determines that the searched different shop does not exist nearer (NO) in the step S24, the product offer data transmitting module 25 transmits product offer data containing purchase product data and product reservation data to a shop terminal 200 of the shop at the destination (step S42). The product offer data transmitting module 25 may transmit only user data, product data, and arrival time data from the purchase product data and the product reservation data.

The product offer data receiving module 250 receives the product offer data. The display module 270 displays a product offer screen based on the received product offer data (step S43).

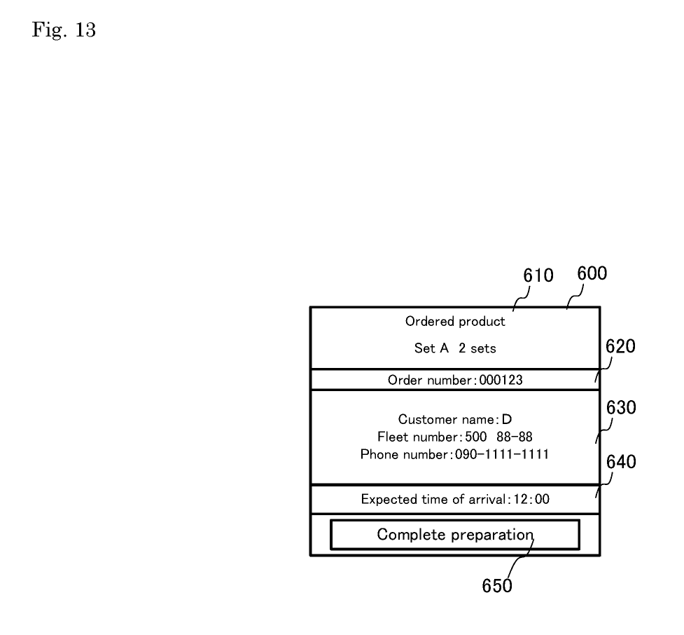

FIG. 13 shows a product offer screen 600 that the display module 270 displays. In FIG. 13, the display module 270 displays a product information display area 610, a number display area 620, a customer information display area 630, an arrival time display area 640, and a preparation completion icon 650 in the product offer screen 600. The display module 270 also displays the name and the number of products in the product information display area 610. The display module 270 also displays the order number in the number display area 620. The display module 270 also displays the name, the fleet number, and the phone number of a customer in the customer information display area 630. The display module 270 also displays the expected time of arrival in the arrival time display area 640. The preparation completion icon 650 receives an operation from a shop employee. The location, the arrangement, the content, etc., of each area that the display module 270 displays can be appropriately changed. The display module 270 may output the items not on the product offer screen but by voice.

The preparation completion input receiving module 271 judges whether or not the preparation completion input receiving module 271 has received an operation from the preparation completion icon 650 (step S44). In the step S44, if judging that the preparation completion input receiving module 271 has not received an operation (NO), the preparation completion input receiving module 271 repeats this step until receiving an input.

On the other hand, if judging that the preparation completion input receiving module 271 has received an operation (YES) in the step S44, the preparation completion notification transmitting module 251 transmits a preparation completion notification to the order management server 10 (step S45). In the step S45, the preparation completion notification is that the product is ready to be offered.

The preparation completion notification receiving module 26 receives the preparation completion notification. The preparation completion notification transmitting module 27 transmits the received preparation completion notification to the navigation terminal 100 (step S46).

The preparation completion notification receiving module 154 receives the preparation completion notification. The preparation completion notification display module 174 displays the received preparation completion notification (step S47).

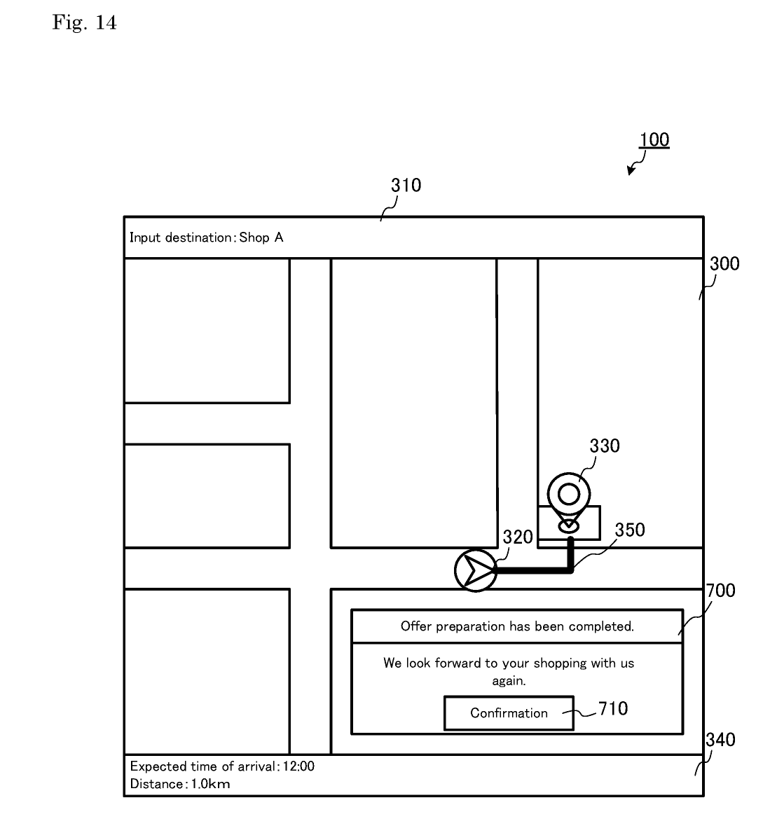

FIG. 14 shows a preparation completion notification 700 that the preparation completion notification display module 174 displays. The preparation completion notification display module 174 superimposed-displays a preparation completion notification 700 on the above-mentioned navigation screen. The preparation completion notification display module 174 displays a message that the preparation of a product has been completed and a confirmation icon 710 in the preparation completion notification 700. The confirmation icon 710 receives an operation from a user. The preparation completion notification display module 174 clears or deletes the preparation completion notification 700 after receiving an operation from the confirmation icon 710. The message, the confirmation icon, etc. that the preparation completion notification display module 174 displays can be appropriately changed. The preparation completion notification display module 174 may not superimposed-display the preparation completion notification 700 on the navigation screen but may display it in a different form, for example, a screen area of the navigation screen. The preparation completion notification display module 174 may display the preparation completion notification 700 at a location different from that of this embodiment. The preparation completion notification display module 174 may also output the preparation completion notification 700 by voice. The preparation completion notification display module 174 may also clear or delete the preparation completion notification 700 after a predetermined time of the display.

### Destination Change Process

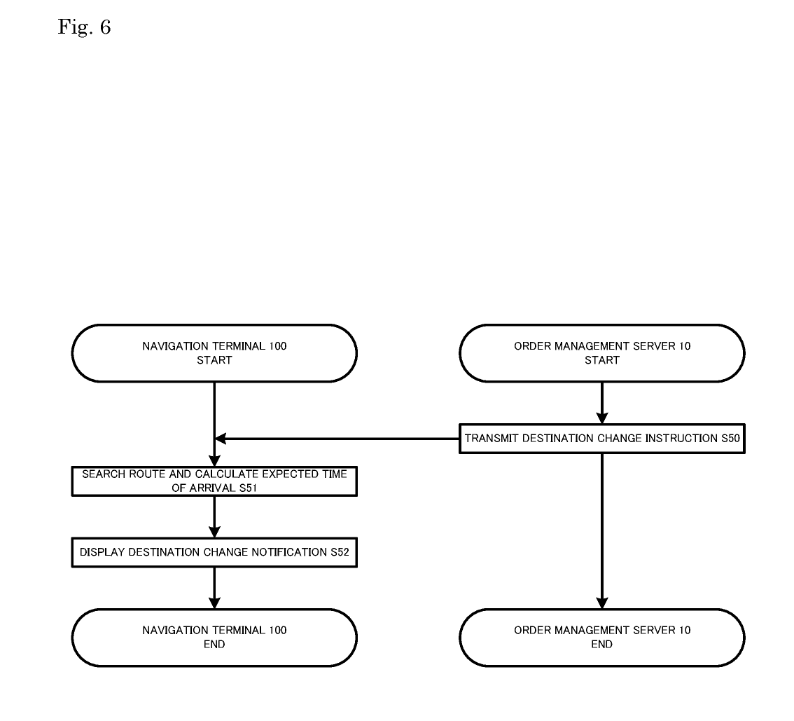

The destination change process executed by the order management server 10 and the navigation terminal 100 will be described below with reference to FIG. 6. FIG. 6 shows the flow chart of the destination change process executed by the order management server 10 and the navigation terminal 100. The tasks executed by the modules of the above-mentioned devices are explained below together with this process.

The destination change instruction transmitting module 28 transmits a destination change instruction to the navigation terminal 100 to change the destination to a different shop (step S50). The destination change instruction contains the name and the location information of a different shop. The destination change instruction may be either the name or the location information of a different shop or may contain other information.

The destination change instruction receiving module 155 receives the destination change instruction. The navigation display module 171 changes the destination based on the received destination change instruction, searches a route to the destination and calculates the expected time of arrival in the same way as the process of the above-mentioned steps S25 and S26 (step S51).

The navigation display module 171 displays the destination change notification that the destination, the route to the destination, and the expected time of arrival have been changed (step S52).

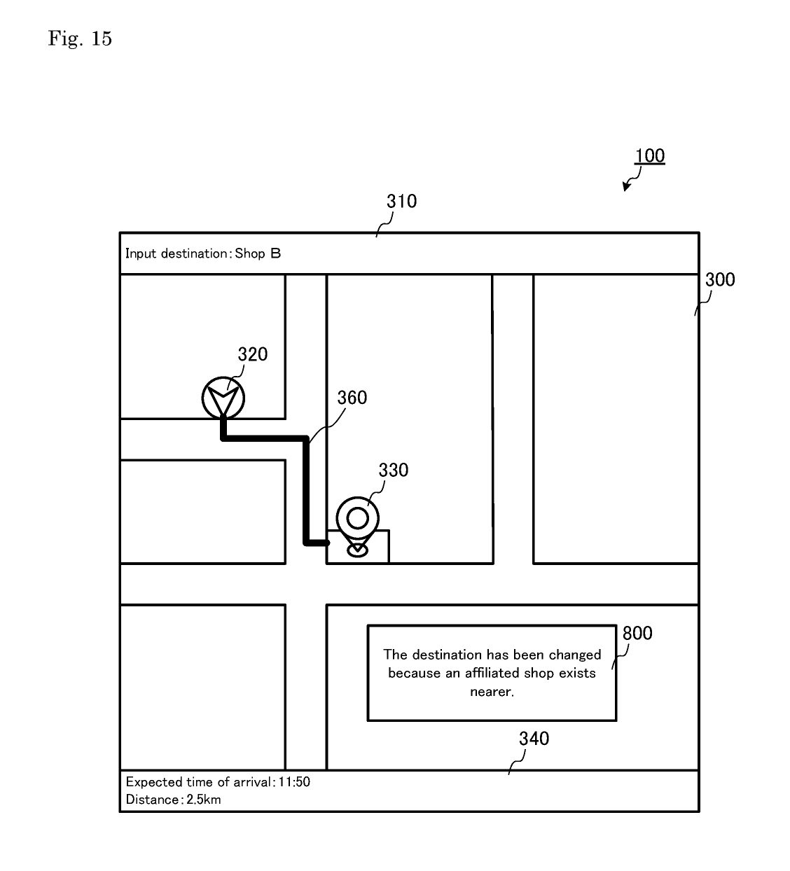

FIG. 15 shows a destination change notification that the navigation display module 171 displays. In FIG. 15, the navigation display module 171 also displays a map a present location icon 320, a destination icon 330, and a navigation route 360 in the map display area 300; and the calculated expected time of arrival and the distance to the destination in the information display area 340, in the same way as the above-mentioned navigation screen. The destination change notification display module 175 superimposed-displays a destination change notification 800 on the navigation screen. The destination change notification display module 175 also displays a message that the destination has been changed. The destination change notification display module 175 may clear or delete the destination change notification 800 after a predetermined time of the display. The content of the destination change notification 800 that the destination change notification display module 175 displays can be appropriately changed. The destination change notification display module 175 may not superimposed-display the destination change notification 800 on the navigation screen but may display it in a different form, for example, a screen area of the navigation screen. The destination change notification display module 175 may also display the destination change notification 800 at a location different from that of this embodiment. The destination change notification display module 175 may also output the destination change notification 800 by voice. The destination change notification display module 175 may also display the destination change notification 800 together with a configuration such as a confirmation icon to receive an operation from a user to clear or delete the destination change notification 800 when receiving an operation from the confirmation icon.

The order management server 10, the navigation terminal 100, and the shop terminal 200 use the changed destination data and the expected time-of-arrival data to perform the process of the above-mentioned step S42.

In the above-mentioned processes, the input may be received not directly from a user but, for example, by voice or another method. Moreover, the above-mentioned processes may be performed by any or all of the devices.

To achieve the means and the functions that are described above, a computer (including a CPU, an information processor, and various terminals) reads and executes a predetermined program. For example, a program is provided in forms recorded in a computer-readable record medium such as a flexible disk, a CD (e.g., CD-ROM), or a DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

1 Product reservation system
10 Order management server
100 Navigation terminal
200 Shop terminal

What is claimed is:

1. A navigation terminal capable of communicating with a predetermined server, searching a route from a present location to a destination, and calculating an expected time of arrival from the present location, comprising:
a destination data input receiving unit that receives an input of destination data on a destination to move forward when moving to a shop;
a destination data transmission unit that transmits the destination data to the server;
an expected time-of-arrival transmitting unit that transmits an expected time of arrival at the destination to the server;
a product selection receiving unit that receives product list data of the shop at the destination to move forward from the server and then receives a selection of a product; and
a product data transmitting unit that transmits product data on the selected product to the server.

2. The navigation terminal according to claim 1, further comprising:
a change instruction receiving unit that receives a change instruction of the destination to move forward from the server; and
a destination change unit that changes the destination based on the change instruction.

3. The navigation terminal according to claim 1, further comprising:
a completion notification receiving unit that receives a completion notification that a product has been prepared from the server; and
a display unit that displays the received completion notification on the navigation terminal itself.

4. A product reservation system comprising:
a destination data input receiving unit that receives an input of destination data on a destination to move forward when moving to a shop;
a navigation unit that searches a route from a present location to a destination and guides a user;
a display unit that displays product list data of the shop at the destination to move forward based on the destination data; and
a notification unit that notifies a terminal of the shop of an expected time of arrival at the destination.

5. The product reservation system according to claim 4, further comprising:
a product selection receiving unit that receives a selection of a product from the displayed product list data;
a different shop search unit that searches a different shop offering the same product as the selected product; and
a destination change unit that transmits a change instruction to change the input destination if a different shop offering the same product is searched.

6. A method of reserving a product, the method being executed by a navigation terminal capable of communicating with a predetermined server, searching a route from a present location to a destination, and calculating an expected time of arrival from the present location, the method comprising the steps of:
receiving an input of destination data on a destination to move forward when moving to a shop;
transmitting the destination data to the server;
transmitting an expected time of arrival at the destination to the server;
receiving product list data of the shop at the destination to move forward from the server and then receiving a selection of a product; and
transmitting product data on the selected product to the server.

7. A method of reserving a product, the method being executed by a product reservation system, the method comprising the steps of:
receiving an input of destination data on a destination to move forward when moving to a shop;
searching a route from a present location to a destination and guiding a user;
displaying product list data of the shop at the destination to move forward based on the destination data; and
notifying a terminal of the shop of an expected time of arrival at the destination.
